(19) United States
(12) Patent Application Publication
(10) Pub. No.: US 2009/0228921 A1
(43) Pub. Date: Sep. 10, 2009

(54) Content Matching Information Presentation Device and Presentation Method Thereof

(76) Inventors: Kazuho Miki, Kawasaki (JP); Hiroshi Kurihara, Kawasaki (JP); Takuji Hamada, Hitachioota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/869,214

(22) Filed: Oct. 9, 2007

(30) Foreign Application Priority Data
Dec. 22, 2006 (JP) 2006-345231

(51) Int. Cl. H04N 5/445

(52) U.S. Cl. 725/38; 725/109

(57) ABSTRACT

A content presentation device which the distributor of a video content can present to a viewer the information which the distributor intends, by adding to and changing the information to present at the time of distribution so that the information may match the content of the video content to distribute, wherein a content matching information presentation server is provided to acquire metadata included in a video content broadcasted by a content provider, to search a keyword based on the metadata, and to compose and distribute the screen with the embedded link information linking to information which is closely related to the hit keyword and which is specified by the distributor of the video content.

### CLAIM OF PRIORITY

The present application claims priority from Japanese patent application serial no. 2006-345231, filed on Dec. 22, 2006, the content of which is hereby incorporated by reference into this application.

### BACKGROUND OF THE INVENTION

The present invention relates to technology of presenting content through a network.

The technology of combining and transmitting video data and video-data accompanying metadata when video content is transmitted to a viewing device through a television broadcasting wave, a network, and the like is disclosed by Document 1 (US 2002/0116471 A1).

Here, the video content shall be composed of video data and metadata. The video data shall indicate the content of a program or video which a viewer watches on a viewing screen, and the digital or analogue data in which the program or video are recorded. The metadata shall refer to pertinent information which accompanies the video content, such as the explanation of video and the screen time.

The technology disclosed by Document 1 employs a method in which the video data to be distributed and the metadata are combined together to one video content and transmitted, and in a viewing device, when the video content is received, the video data is extracted from the combined data and displayed and/or reproduced, and the remaining metadata is displayed and/or reproduced separately.

For example, in Electronic Program Guide (EPG), video data and EPG data are distributed separately. The feature of the invention of Document 1 described above can be found in the fact that each data is combined together to one data and distributed.

In the present application, one who makes video content (video data and metadata) and provides broadcast (program production station etc.) shall be called a content provider, and one who distributes secondarily the video content which is provided by the content provider shall be called a content distributor.

However, in the invention disclosed by Document 1, when a content distributor distributes video content, the information which the content distributor wants to present cannot be added. Therefore, the information which the content distributor intends to distribute cannot be presented to a viewer.

For example, it becomes possible, using the above-mentioned technology, for the news video data providers (a program production station, broadcasting station, etc.) to combine metadata (EPG) and video content and to distribute the combined content to viewing devices (television receiving set etc.).

However, when the content distributor, who distributes such news video content secondarily, wants to combine the news video content and the commercial advertisement and pertinent information on own products according to the genre and content of the video content, it is necessary for the content distributor to have the contents of news notified in advance by the content provider before the content provider starts supply and to be prepared for producing the commercial advertisement video which matches well with the contents of news.

For example, suppose that there is a distributor of video content, such as a financial institutions etc., who wants to make a viewer refer to the news (the finance and business information of the news) for motivating the purchase of own financial products or improving the customer satisfaction measurement. When one wants to display, on the same viewing screen as the video content, the information of own products which has a close relation to the video content, one has to have the content of the video content taught in advance.

Actually, however, it is difficult to make the above-mentioned preparations in advance to the news video content or the broadcast content which is featured by the high freshness of information, since there are time restrictions as well as high load in making the preparations.

The present invention is made paying attention to such a conventional problem.

### SUMMARY OF THE INVENTION

The present invention provides a content presentation device in which a distributor of content, such as video, is able to extract, at the time of distribution, information which matches with the content of the video content to distribute from the previously-prepared additional information such as an advertisement of the own products. Using the content presentation device, the distributor of content is further able to create a viewing screen composed of the extracted information and the video content concerned and to present to a viewer the information which the distributor wants to present.

As a means to solve the above-mentioned problem, the present invention provides the content presentation device which is able

to store a predetermined keyword and additional information and priorities in a manner associated with each other;

based on video data broadcasted and metadata data corresponding to the video data concerned, to search a keyword to the metadata data and to extract additional information;

to impart a priority to the additional information, according to the priorities;

to create a content-viewing screen information based on the video data and the prioritized additional information; and

to transmit the content-viewing screen information responding to the request to transmit from a viewing terminal.

According to the present invention, the distributor of content, such as video, is able to extract, at the time of distribution, the information matched with the content of the content concerned to distribute, from the previously-prepared additional information such as an advertisement of the own products. The distributor is further able to create a viewing screen composed of the extracted information and the content concerned and to present to a viewer the information which the distributor wants to present.

### BRIEF DESCRIPTION OF THE DRAWINGS

Preferred embodiments of the present invention will now be described in conjunction with the accompanying drawings, in which;

FIG. 1 is a block diagram illustrating a content distribution system according to a first embodiment of the present invention;

FIG. 2 is a block diagram illustrating a content matching information presentation server;

FIG. 3 is a diagram illustrating a format of a video contents storage area;

FIG. 4 is a diagram illustrating a format of an additional information storage area;

FIG. 5 is a diagram illustrating a format of an additional information correspondence table;

FIG. 6 is a diagram illustrating a format of an additional information priority table;

FIG. 7 is a block diagram illustrating an additional information registration server;

FIG. 8 is a flow chart illustrating procedure in the first embodiment;

FIG. 9 is a chart illustrating a distribution screen in the first embodiment;

FIG. 10 is a chart illustrating a screen linked from the distribution screen in the first embodiment;

FIG. 11 is a chart illustrating a distribution screen in the first embodiment;

FIG. 12 is a chart illustrating a screen linked from the distribution screen in the first embodiment;

FIG. 13 is a flow chart illustrating maintenance procedure in the first embodiment; and

FIG. 14 is a flow chart illustrating procedure in a second embodiment.

### DETAILED DESCRIPTION OF THE PREFERRED EMBODIMENTS

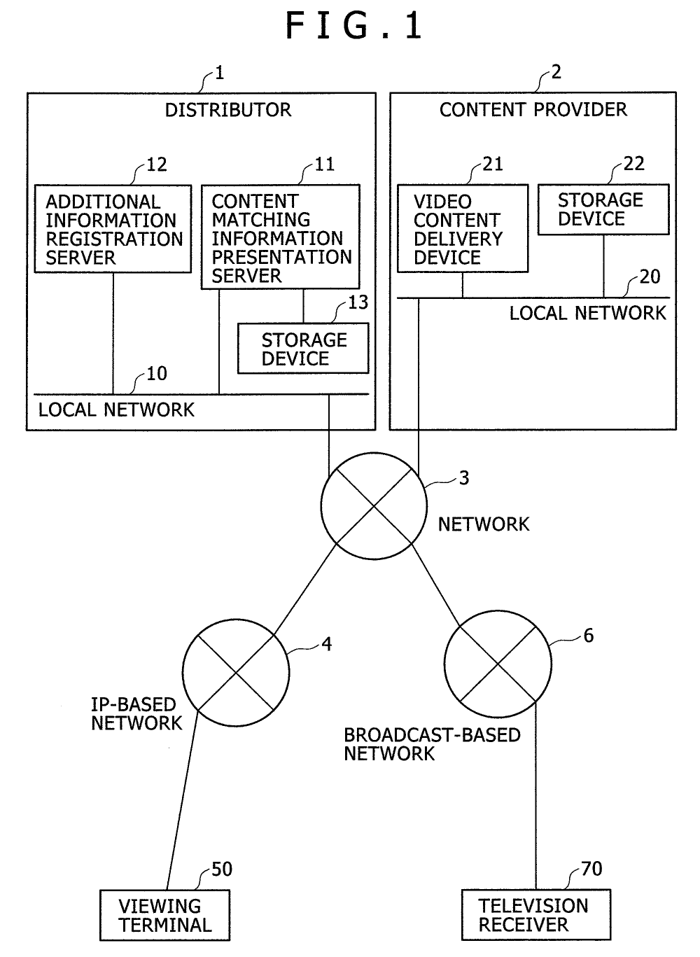

Hereinafter, with reference to FIGS. 1 to 12, a first embodiment is explained.

FIG. 1 is a block diagram illustrating a content distribution system according to the first embodiment.

In the present embodiment, it is assumed that there exist a base 1 of a distributor who distributes content, and a base 2 of a content provider who provides the content distributor with the content. Moreover, it is assumed that the base 1 and the base 2 are connected through a network 3. In the present embodiment, the network 3 is an IP-based network which uses an IP address as a communication method. However, the network 3 is not limited to this, it may be a broadcast-based network which uses a broadcast wave etc., or it may be a composite of the IP-based network and the broadcast-based network.

In addition, the present embodiment further includes a viewing terminal 50 such as a personal computer or a portable terminal which are used in a home etc. when a viewer views content, a television receiver 70 to be used in viewing broadcast, and the like. These devices are connected to an IP-based network 4 through the public network etc. or to a network 6 using a broadcast wave.

Furthermore, the network 3 is connected to the IP-based network 4 to which a viewing terminal 50 is connected. The network 3 is connected also to the broadcast-based network 6 to which the television receiver 70 is connected.

Through these networks, the viewing terminal 50 and the television receiver 70 can view content by communicating with the base 1 of the distributor and the base 2 of the content provider.

In the base 1 of the distributor, a local network 10 connected to the network 3 through network equipment (not shown) is provided.

A content matching information presentation server 11 which assumes the role of distribution of content, and an additional information registration server 12 which assumes the role of maintenance of information to be added to the content are connected to the local network 10. A storage device 13 which stores the video content and the information to be added is connected with the content matching information presentation server 11.

In the base 2 of the content provider, a local network 20 connected to the network 3 through network equipment (not shown) is provided.

A video content delivery device 21 and a storage device 22 are connected to the local network 20.

In the present embodiment, the storage device 22 is connected with the video content delivery device 21 through the local network 20. Alternatively, the storage device 22 may be directly connected with the video content delivery device 21, without passing through the local network 20.

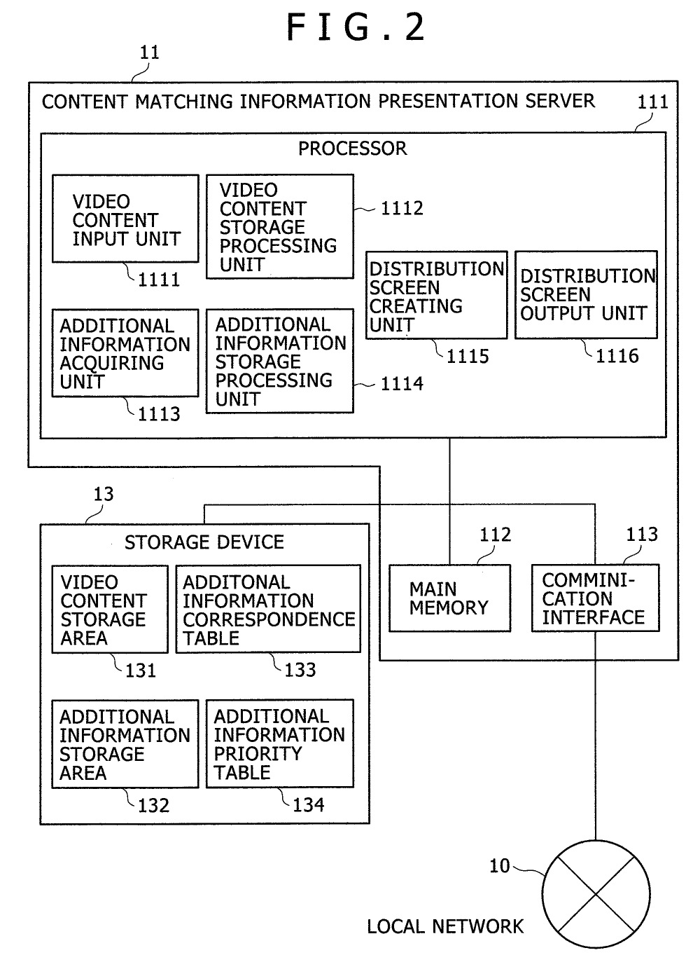

As shown in FIG. 2, the content matching information presentation server 11 is composed of a processor 111, a main memory 112, and a communication interface 113 for connecting to the local network 10.

The processor 111 includes, as functional units, a video content input unit 1111 to receive video content as an input, a video content storage processing unit 1112 to store the received video content, an additional information acquiring unit 1113 to acquire additional information according to link information, an additional information storage processing unit 1114 to store the acquired additional information, a distribution screen creating unit 1115 to create a distribution screen from the video content and the additional information, and a distribution screen output unit 1116 to perform output such as transmitting the created distribution screen.

These functional units are realized through the execution of instruction codes developed in the main memory 112, by the processor 111.

The storage device 13 stores a video content storage area 131, an additional information storage area 132, an additional information correspondence table 133 to store keywords and the stored additional information in a manner associated with each other, and an additional information priority table 134 to store priorities which are used at the time of choosing the additional information to present, in distributing the video content with plural keywords.

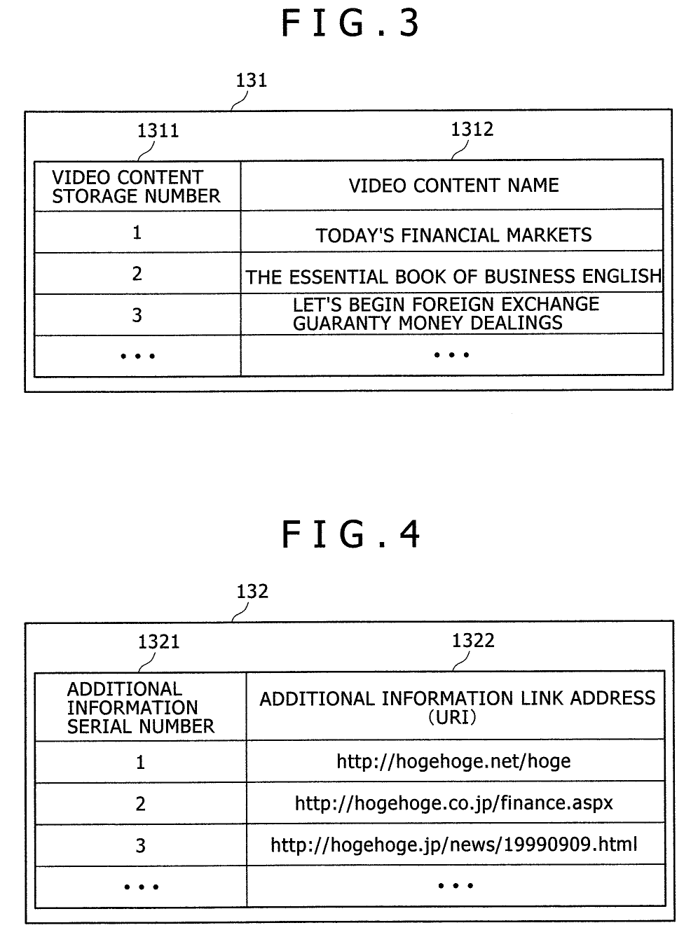

The video content storage area 131 allotted in the storage device 13 stores the video content in a data format as illustrated in FIG. 3. That is, in the video content storage area 131, one record of the video content is stored in units of a program or in units of one corner of the program. Each record constitutes a unit of recording of a video content storage number 1311 which enables identification of the video content and a video content name 1312 which indicates the name of the video content.

The additional information storage area 132 allotted in the storage device 13 stores the additional information in a data format as illustrated in FIG. 4. That is, one record is stored per pieces of additional information. Each record constitutes a unit of recording of additional information serial number 1321 which enables identification of the additional information and an additional information link address 1322 which indicates a Uniform Resource Identifier (URI) of the additional information.

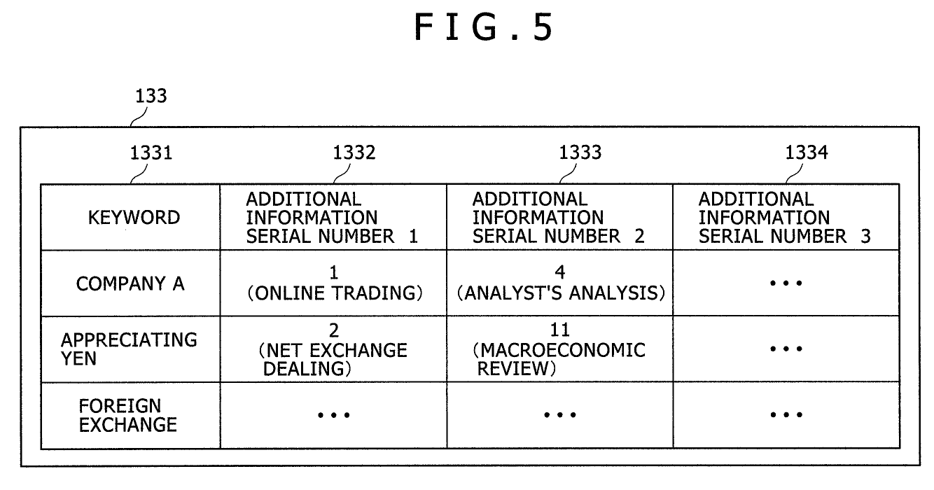

The additional information correspondence table 133 allotted in the storage device 13 stores an additional information corresponding information in a data format as illustrated in FIG. 5. That is, one record is stored per keyword. In each record, a keyword 1331 and the additional information serial number relevant to the keyword up to three pieces (1332, 1333, 1334) can be stored. When the additional information serial number is stored in relationship to the keyword, the additional information specified by the additional information serial number is presented when distributing the content including the related keyword.

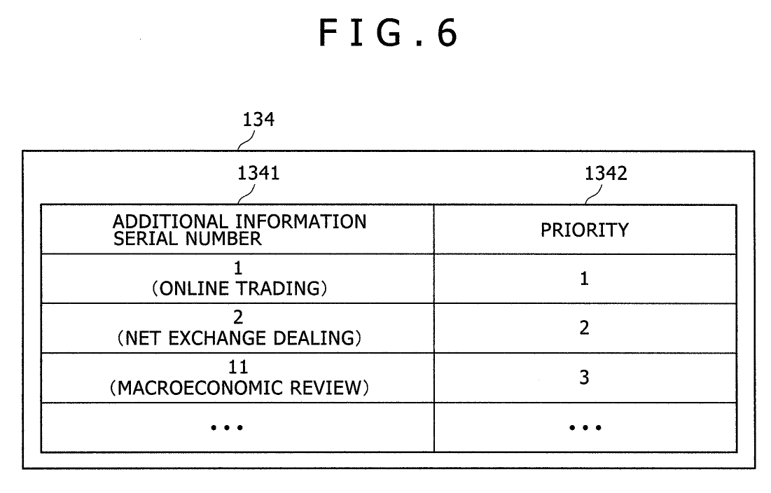

The additional information storage area 134 allotted in the storage device 13 stores the presentation priority of the additional information in a data format as indicated in FIG. 6. That is, one record is stored per additional information serial number. Each record constitutes a unit for recording the additional information serial number 1341 which enables identification of the additional information and the priority 1342 which indicates the relative priority among pieces of the additional information.

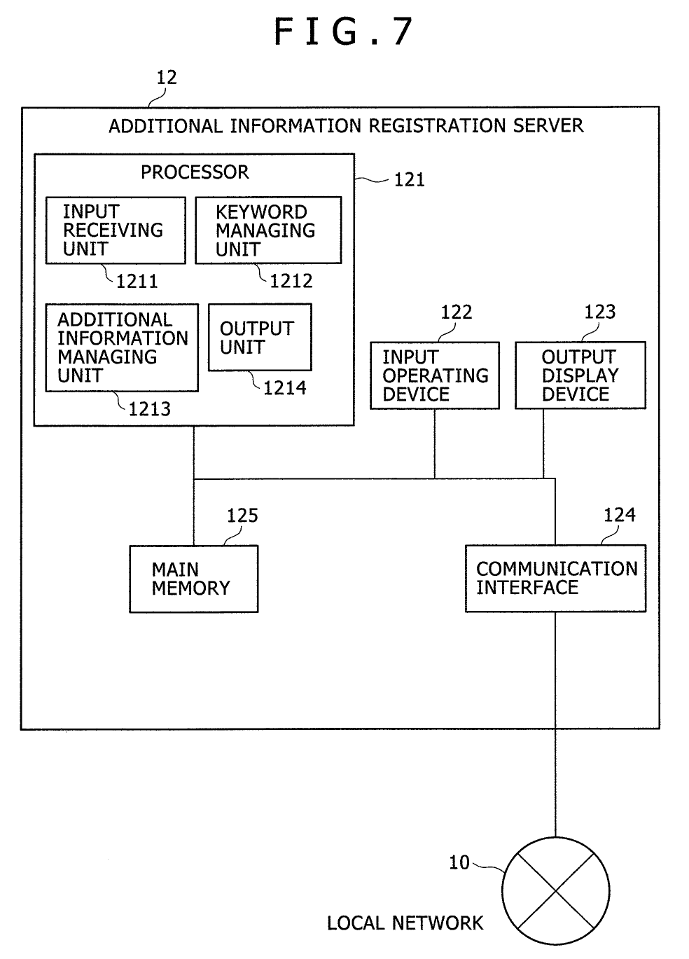

Next, the structure of the additional information registration server 12 is explained using FIG. 7. As illustrated in FIG. 7, the additional information registration server 12 includes a processor 121, an input operation device 122 such as a keyboard and a mouse, an output display device 123 such as a display screen, a communication interface 124 such as a network interface for connecting to the local network 10, and a main memory 125.

The processor 121 includes, as functional units, an input receiving unit 1211 to receive a content which the user inputs by operating the input operation device 122, a keyword managing unit 1212 to edit a keyword based on the received input, an additional information managing unit 1213 to edit the additional information, and an output unit 1214 to output information to an output display device such as a screen.

These functional units are realized through the execution of instruction codes developed in the main memory 125, by the processor 121.

Next, operation of the content distribution system according to the first embodiment is explained using FIG. 1.

The content distribution system of the present embodiment operates at a trigger of process in which the content provider transmits, from the base 2 by the video content delivery device 21, the video content which includes the metadata stored in the storage device 22.

Upon receiving the video content transmitted, the content matching information presentation server 11 arranged at the base 1 of the distributor scans the metadata included in the video content concerned, extracts a keyword, creates a viewing screen by adding the additional information related to the keyword, and transmits to the network 3 successively.

This is repeatedly carried out in accordance with the speed of transmission until the video content concerned terminates. (This is called a live distribution although some degree of time-lag occurs compared with the video content transmitted by a content provider, such as a broadcasting station.)

With the viewing terminal 50 or the television receiver 70, a viewer receives the live-distributed viewing screen, and reproduces it as video. Consequently, the viewer can view the video content and the video content-related additional information.

The above is the outline of the operation of the content distribution system according to the first embodiment.

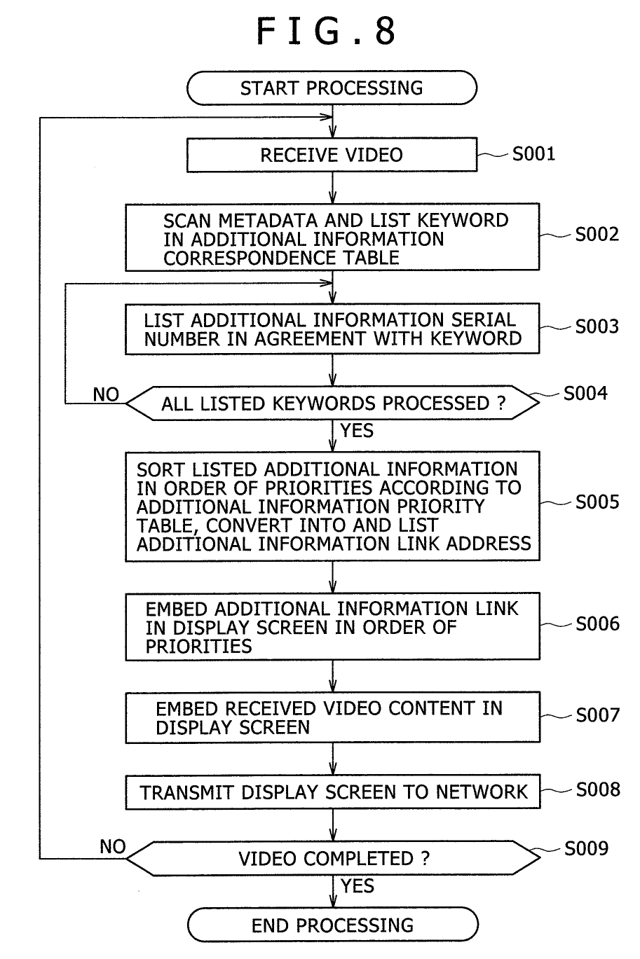

Next, the details of the operation in the first embodiment are explained in the following, based on the flow chart of FIG. 8.

When the content provider transmits, using the video content delivery device 21, the video content including the metadata stored beforehand in the storage device 22 arranged at the base 2, the transmitted video content concerned is streamed as data in the network 3 after passing through the local network 20. In addition, although in the example described above, the video data and the metadata are transmitted simultaneously, the present invention is not limited to the example, and the video data and the metadata may be transmitted separately.

In the content matching information presentation server 11 arranged at the base 1 of the distributor, the video content input unit 1111 receives the video content concerned through the communication interface 113.

The video content input unit 1111 scans the received video content, and extracts the information which is marked up by a tag or the like, called metadata. In addition, in the present embodiment, the recording mode of the metadata assumes BML (Broadcast Markup Language) etc.; however, it may be another recording mode using markup languages, such as Extensible Markup Language (XML), etc.

In addition, the video content storage processing unit 1112 stores the extracted metadata and the video-data part of the video content in the main memory 112 (Step 001).

Next, to the metadata stored in the main memory 112, the distribution screen creating unit 1115 investigates, using a character string search method or the like, the existence of the keyword 1331 recorded on the additional information correspondence table 133, and lists the keyword 1331 in agreement (Step 002).

Then, the distribution screen creating unit 1115 lists the additional information serial numbers 1332 to 1334 related to the keyword 1331 which is listed at Step 002 from the additional information correspondence table 133 (Step 003). Moreover, the present process is practiced for all the keyword 1331 listed at Step 002 (Step 004).

Next, the distribution screen creating unit 1115 rearranges the additional information serial numbers 1332 to 1334 listed at Steps 003 and 004, according to the priority 1342 which is acquired with reference to the additional information serial number 1341 recorded on the additional information priority table 134.

For the additional information serial numbers 1332 to 1334 rearranged on a list, the distribution screen creating unit 1115 replaces the additional information with the corresponding additional information link address 1322, referring to the additional information storage area 132 (Step 005).

Based on the list of the additional information link address 1322 obtained by the replacement at Step 005, the distribution screen creating unit 1115 embeds the link acquired from the additional information link address 1322 according to the priority, into the additional-information display column of the form (not shown) of the viewing screen to be used for a screen output.

In the present embodiment, the additional information link address 1322 is expressed by URI, and embedding is carried out by arranging URIs one by one on the screen layout for an additional-information display (Step 006).

Alternatively, instead of arranging URIs, the distribution screen creating unit 1115 may acquire and arrange the content (for example, a text, a picture, an animation, an HTML document etc.) which can be accessed by URIs.

In this case, in order to acquire the content which can be accessed by the above-described URI, the distribution screen creating unit 1115 transfers the processing to the additional information acquiring unit 1113. The additional information acquiring unit 1113 acquires the content indicated by URI (that is, additional information) and requests the additional information storage processing unit 1114 to store and arrange the acquired additional information.

Next, the distribution screen creating unit 1115 embeds the video content received at Step 001, into the specified position on a screen layout, thereby creating the screen (Step 007).

Before transmitting or distributing the screen completed at Step 007 to the viewing terminal 50 or the television receiver 70 through the communication interface 113 (Step 008), the distribution screen output unit 1116 may alternatively adopt a scheme to transmit the screen to a mobile terminal device after transforming the screen into a mobile-terminal-device-oriented screen structure using the existing content conversion technology etc., in consideration of the case where the viewing terminal 50 may be a mobile terminal device, for example, a mobile phone unit, PDA (Personal Digital Assistants), etc.

By executing repeatedly the above-mentioned Steps 001 to 008 until the video content terminates and by transmitting the distribution screen, it becomes realizable that the distributor of the video content makes addition and alteration to the live-distributed information at the time of distribution so that the information may match the content of the video content to be distributed and presents to a viewer the information which the distributor intends.

By receiving the viewing screen created, transmitted (live-distributed) through the above-mentioned Steps S001 to S009 and reproducing as a video, with the viewing terminal 50 and the television receiver 70, the viewer can view the video content and the additional information relevant to it.

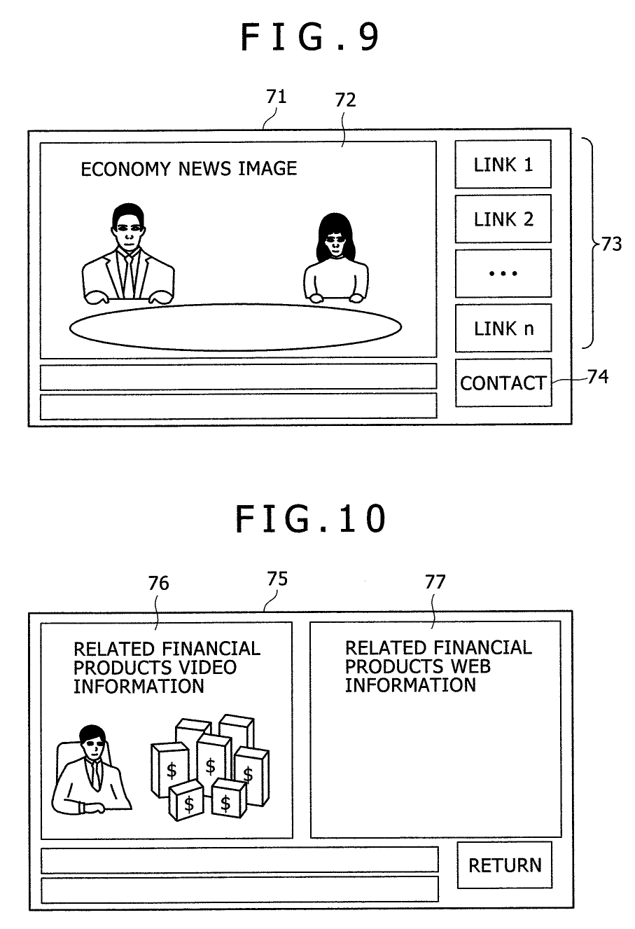

A screen image 71 illustrated in FIG. 9 is the example of an image which the viewing terminal 50 or the television receiver 70 receives and displays the viewing screen distributed by the content matching information presentation server 11 of the content distributor.

The screen image 71 is composed of a video content screen 72 and a link display area 73. The screen image 71 is the screen created at Step 007 of FIG. 8. The video content transmitted from the video content delivery device 21 of the content provider is embedded in the video content screen 72 (the news picture is displayed in FIG. 9). In the link display area 73, the link information arranged in order of the priority is embedded as a URI link from the top of the screen toward the bottom.

When the viewer operates operation equipment in the screen of FIG. 9 so that Link 1 may be chosen, the screen of FIG. 9 is changed off to the screen of FIG. 10.

FIG. 10 illustrates a screen image 75 obtained when URI indicated by Link 1 in the screen of FIG. 9 is accessed.

The screen image 75 is composed of a video content screen 76 (related financial products video information) and a related information screen 77 (related financial products WEB information). This screen structure is simply an illustration and the screen is not necessarily displayed with this structure. As an alternative, the screen may simply display a dynamic information screen as in the video content screen 76 or a static information screen as in the related information screen 77. As a further alternative, the video content screen 72, the video content screen 76, and the related information screen 77 may be displayed on the same screen.

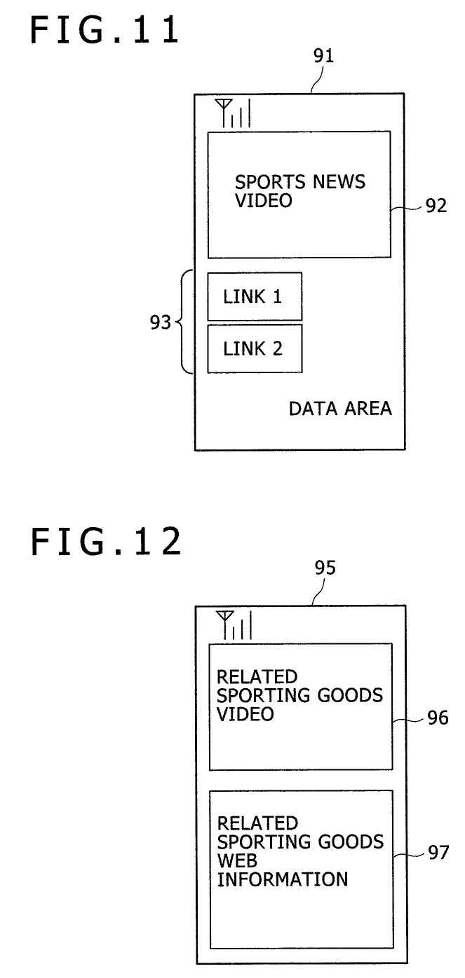

Similarly, FIGS. 11 and 12 illustrate a screen image in a case that the viewing terminal 50 is mobile equipment such as a cellular phone.

FIG. 11 is the example in which a screen image 91 including a video content screen 92 and a link display area 93 is displayed, as in FIG. 9. The video content screen 92 and the link display area 93 are vertically arranged due to the restricted size of the screen display area.

FIG. 12 is the example in which a screen image 95 including a video content screen 96 (related sport goods video information) and a related information screen 97 (related sport goods WEB information) is displayed, as in FIG. 10.

Among the distribution system of the content described above, the following explains about the maintenance function used for the management of keywords and the management of priorities used in determining the additional information to distribute.

The additional information registration server 12 provides the function of the management of keywords and the management of priorities of the present embodiment.

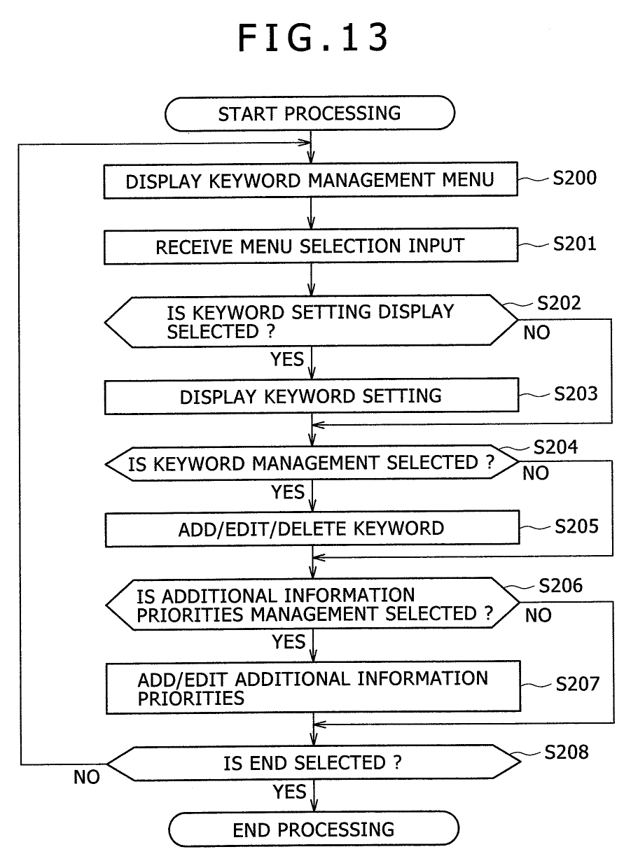

The flow of processing of the management is explained using the flow chart of FIG. 13.

Upon receiving a menu display request from the input operation device 122, the input receiving unit 1211 provided in the processor 121 of the additional information registration server 12 composes a keyword management menu panel, and requests the output unit 1214 to display the keyword management menu panel. The output unit 1214 outputs the menu panel to the output display device 123, thereby displaying the menu panel (Step 200).

Through the input operation device 122, the input receiving unit 1211 receives the content inputted on the keyword management menu panel displayed on the output display device 123 at Step 200, and stores the inputted content in a storage device, such as the main memory 125 (Step 201).

If the inputted content is “display keyword setup” (“YES” at Step 202), the input receiving unit 1211 displays the keyword setup by list (Step 203). If the inputted content is not “display keyword setup” (“NO” at Step 202), Step 203 is skipped.

Specifically, at Step 203, the keyword managing unit 1212 accesses the storage device 13 included in the content matching information presentation server 11 connected to the network 10 through the communication interface 124, reads the additional information correspondence table 133 stored in the storage device 13, rearranges the keyword column 1331 in a fixed order (in alphabetical order etc.), and lists it with additional information serial numbers 1332 to 1334.

The output unit 1214 outputs the listed keyword to the output display device 123.

Subsequently, if the inputted content is “management of keyword” (“YES” at Step 204), the input receiving unit 1211 displays an operation screen on which a keyword can be chosen and edited, added newly, or deleted. The operation received by the input receiving unit 1211 is then executed (Step 205). If the inputted content is not “management of keyword” (“NO” at Step 204), processing at Step 205 is skipped.

Specifically, at Step 205, the keyword managing unit 1212 reads in the additional information correspondence table 133 stored in the storage device 13, rearranges the keyword column 1331 in a fixed order (in alphabetical order etc.), and, lists it with additional information serial numbers 1332 to 1334.

The output unit 1214 outputs the listed keywords to the output display device 123 (almost the same as that of Step 203). Then, accepting the editing for the select-and-inputted keyword, the additional information correspondence table 133 is edited, or accepting the new keyword input, the additional information correspondence table 133 is appended. Or accepting the deletion directions for the select-and-inputted keyword, the corresponding keyword 1331 and additional information serial numbers 1332 to 1334 are deleted from the additional information correspondence table 133.

Next, if the inputted content is “management of additional information” (“YES” at Step 206), the input receiving unit 1211 displays an operation screen on which the selection and edit of the additional information, the addition of new additional information, or the deletion of the existing additional information can be performed. Subsequently the input receiving unit 1211 executes the editing that the user specifies (Step 207). If the inputted content is not “management of additional information” (“NO” at Step 206), the processing at Step 207 is skipped.

Specifically, at Step 207, the additional information managing unit 1213 reads the additional information storage area 132 and the additional information priority table 134, both of which are stored in the storage device 13, rearranges the additional information link address 1322 in a fixed order (in alphabetical order etc.) such as the order of the additional information serial number 1321, and lists the additional information link address 1322 with the corresponding additional-information priority 1342.

The output unit 1214 outputs the listed additional information link address 1322 and the listed additional-information priority 1342 to the output display device 123. Then, accepting the editing of the select-and-inputted additional information link address, the additional information storage area 132 and the additional information priority table 134 are edited. Alternatively, accepting a new additional information input, the additional information storage area 132 and the additional information priority table 134 are appended. As a further alternative, accepting the deletion directions for the select-and-inputted additional information, the records of corresponding items are deleted from the additional information storage area 132, the additional information correspondence table 133, and the additional information priority table 134. The records targeted for deletion are the additional information serial number 1321 and the additional information link address 1322 of the additional information storage area 132, the additional information serial numbers 1332 to 1334 of the additional information correspondence table 133, and the additional information serial number 1341 and the priority 1342 of the additional information priority table 134.

Furthermore, as another alternative, it is also possible to change only the presentation priority of the additional information link address. The additional information managing unit 1213 receives directions of the priority change for the select-and-inputted additional information, and carries out editing of the priority 1342 of the additional information priority table 134 (detail of Step 207).

Finally, if the inputted content is “end of the processing” (“YES” at Step 208), the input receiving unit 1211 terminates the maintenance processing concerned. If the inputted content is not “end of the processing” (“NO” at Step 208), the control returns to Step 200 and the processing is executed again from Step 200.

As described above, according to the present embodiment, the video content which a video-content provider transmits is received by the content matching information presentation server 11 which a content distributor provides, the additional-information link in close relationship to the keyword which is the metadata included in the video content is selected to compose a viewing screen. Thereby, the video content is reproduced and distributed in almost real time (live distribution), and the video content can be presented to a viewer. Therefore, it is possible to distribute to the viewer the viewing screen which incorporates the advertisement etc. according to the content of the video content at the time of distribution, without changing the video content itself.

For the viewer, information deeply connected with the content which the viewer is viewing (the viewer has interest) can be obtained. Furthermore, since the added presentation information is the link presented from the distributor who the viewer trusts, there is little concern about the reliability of information; therefore, the link information which can be used with a sense of reliability is provided to the user.

Moreover, in the present embodiment, the content matching information presentation server 11 receives the broadcast transmitted from the video content delivery device 21 of the content provider, and composes and distributes the viewing screen in real time (live distribution). However, the acquisition method of the video content is not limited to the case.

For example, one may receive the video content from the video content delivery device 21, using a file transfer or the method which transmits and receives a package of data file to which the video content has been converted.

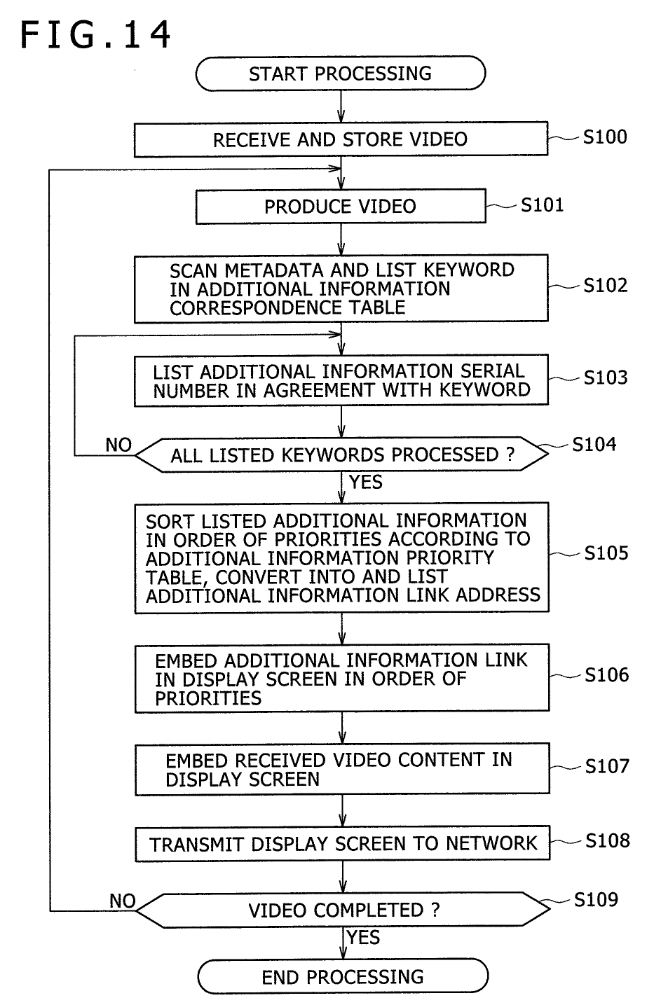

A second embodiment is explained in the following with reference to FIG. 14.

The second embodiment is the same as the first embodiment in the fundamental structure. However, operation of the video content storage processing unit 1112 which is included in the processor 111 of the content matching information presentation server 11 is different.

That is, the difference lies in the operation at Step 100 illustrated in FIG. 14, and the addition of Step 101.

Step 100 is the processing corresponding to Step 001 in the first embodiment. Step 100 is the processing to receive the transmitted video, and to store the data file of the received video content in the video content storage area 131 of the storage device 13, by the action of the video content storage processing unit 1112 of the storage device 13. The storing of the data file itself to the storage device 13 is not included in Step 001 of the first embodiment. By the storing to the storage device 13, the video-content reception by file format becomes attainable in the second embodiment.

Step 101 is the processing corresponding to the processing carried out between Step 100 (corresponding to Step 001 of the first embodiment) and Step 102 (corresponding to Step 002 of the first embodiment). In the first embodiment, the video content input unit 1111 receives the transmitted video-content data flowing on the local network 10, and adds the additional information. However, the video content itself is distributed fundamentally as it is. Therefore, the received data does not need to be reproduced again by the content matching information presentation server 11. In the second embodiment, however, the video content input unit 1111 receives the video content by file format at Step 100; therefore, the video content input unit 1111 needs to reproduce the file-formatted video content. This is the reason for adding Step 101.

Excluding these two Steps S100 and S101, Steps S102 to S109 perform the same operation as that in the first embodiment basically.

As a modification of the second embodiment, in Step 107, just before transmitting, the viewing screen may be stored in the video content storage area 131 of the storage device 13; thereby the data file of the video content may be acquired.

The second embodiment described above and the present modification of the second embodiment allow the realization of a distributing method in which a distributor distributes according to a determined schedule, and VOD (Video On Demand) which enables a viewer to start viewing in response to a viewing request made when the viewer desires.

What is claimed is:

1. A content presentation device comprising:
a storage unit operable to store a predetermined keyword and additional information in a manner to be associated with each other;
a receiving unit operable to receive content data and metadata data corresponding to the content data;
an extracting unit operable to search a keyword stored in said storage unit for the metadata data received by said receiving unit, and to extract additional information associated with the keyword which is found in the metadata data;
a screen information creating unit operable to create content-viewing screen information, based on the content data received by said receiving unit and the additional information extracted by said extracting unit; and
a transmitting unit operable to transmit to a network the content-viewing screen information created by the screen information creating unit.

2. The content presentation device according to claim 1 further comprising:
a second storage unit operable to store predetermined priorities for pieces of said additional information; and
a priority imparting unit operable to impart a priority to the additional information acquired by said extracting unit, in accordance with said priorities stored in said second storage unit.

3. The content presentation device according to claim 2 further comprising:
a third storage unit operable to store content data and metadata data corresponding to the content data;
an extracting unit operable to search a keyword stored in said storage unit for metadata data stored in said third storage unit, and to extract additional information associated with the keyword which is found in said metadata data;
a screen information creating unit operable to create content-viewing screen information, based on the content data stored in said third storage unit and the additional information with the priority imparted by said priority imparting unit; and
a transmitting unit operable to transmit to a network the content-viewing screen information created by said screen information creating unit in response to a request to transmit from a viewing terminal.

4. A content presentation device directed to a mobile terminal, the content presentation device comprising:
a storage unit operable to store a predetermined keyword and additional information in a manner to be associated with each other;
a receiving unit operable to receive content data and metadata data corresponding to the content data;
an extracting unit operable to search a keyword stored in said storage unit for the metadata data received by said receiving unit, and to extract additional information associated with the keyword which is found in the metadata data;
a screen information creating unit operable to create content-viewing screen information directed to the mobile terminal, based on the content data received by said receiving unit and the additional information extracted by said extracting unit; and
a transmitting unit operable to transmit to the mobile terminal the mobile-terminal-directed content-viewing screen information created by said screen information creating unit.

5. The content presentation device according to claim 4 further comprising:
a second storage unit operable to store predetermined priorities for pieces of said additional information;
a priority imparting unit operable to impart a priority to the additional information acquired by said extracting unit, in accordance with said priorities stored in said second storage unit;
a screen information creating unit operable to create content-viewing screen information directed to the mobile terminal, based on the content data received by said receiving unit and the additional information with the priority imparted by said priority imparting unit; and
a transmitting unit operable to transmit to the mobile terminal the mobile-terminal-directed content-viewing screen information created by said screen information creating unit.

6. The content presentation device according to claim 5 further comprising:
a third storage unit operable to store content data and metadata data corresponding to the content data;
an extracting unit operable to search a keyword stored in said storage unit for the metadata data stored in said third storage unit, and to extract additional information associated with the keyword which is found in said metadata data;
a screen information creating unit operable to create content-viewing screen information directed to the mobile terminal, based on the content data stored in said third storage unit and the additional information with the priority imparted by said priority imparting unit; and
a transmitting unit operable to transmit to the mobile terminal the mobile-terminal-directed content-viewing screen information created by said screen information creating unit in response to a request to transmit from a viewing terminal.

7. A content presentation method comprising the steps of:
storing a predetermined keyword and additional information in a manner to be associated with each other in a storage unit;
receiving content data and metadata data corresponding to the content data by a receiving unit;
performing additional information extraction by searching a keyword stored in said storage unit for the metadata data received by said receiving unit and by extracting additional information associated with the keyword which is found in said metadata data;
performing screen information creation by creating content-viewing screen information, based on the content data received by said receiving unit and the additional information extracted in said performing additional information extraction; and
transmitting to a network the content-viewing screen information created in said performing screen information creation.
